(19) United States
(12) Patent Application Publication
(10) Pub. No.: US 2026/0017496 A1
(43) Pub. Date: Jan. 15, 2026

(54) COMPUTING SYSTEMS AND METHODS FOR GENERATING A TRAINING DATASET FOR A RERANKER MODEL

(71) Applicant: The Toronto-Dominion Bank, Toronto (CA)

(72) Inventors: IIan GOFMAN, Toronto (CA); Jiapeng WU, Toronto (CA); Raunaq SURI, Mississauga (CA); Guangwei YU, Toronto (CA); Maksims VOLKOVS, Toronto (CA)

(21) Appl. No.: 18/771,319

(22) Filed: Jul. 12, 2024

(51) Int. Cl. G06N 3/0475; G06F 16/2457; G06N 3/09

(52) U.S. Cl. CPC G06N 3/0475; G06F 16/24578; G06N 3/09

(57) ABSTRACT

Systems and methods for generating a training dataset for a reranker model. The methods comprise, for each document of a set of documents, using a large language model (LLM) to generate one or more synthetic queries related to the document; for each generated synthetic query, using the LLM to rank a plurality of documents of the set of documents associated with the synthetic query based on a relevance of the plurality of documents to the synthetic query; and generating the training dataset to include each synthetic query and the ranking of the plurality of documents associated with that synthetic query.

### TECHNICAL FIELD

The disclosed example embodiments relate to computer-implemented methods and system for generating a training dataset for a reranker model, and specifically a reranker model that forms part of an information retrieval system.

### BACKGROUND

Information retrieval (IR) is the systematic process of extracting relevant information from a corpus of documents in response to user queries. Some IR systems implement a two-stage retrieval system. In the first stage, which may be referred to as the retriever stage, a retriever model is used to retrieve a subset of relevant documents from a larger corpus. The retrieval model may implement techniques such as embedding. In embedding, an embedding model is used to compute a text embedding (which may also be referred to vector or simply an embedding) for each document that represents the words in the document, then the embedding model is used to compute a text embedding for a received query. The text embedding for the query is then compared to the text embeddings for the documents to compute a similarity score therefor. The document with the top k similarity score may then be retrieved for processing in the second stage.

In the second stage, which may be referred to as the reranker stage, a reranker model is used to rank or order the retrieved documents based on their relevance to the query. A reranker model (which, in some cases, may be implemented as a cross-encoder) is a language model that is designed to compute a score for each of the retrieved documents that indicates the relevance of the document to the query. The scores can then be used to reorder the documents retrieved in the first phase by relevance to the query. The objective of the reranker is generally to provide a more precise list than that obtained in the first phase. The reranker model is generally, but not necessarily, a more expensive model, in terms of resources and time, compared to the retriever model.

### SUMMARY

The following summary is intended to introduce the reader to various aspects of the detailed description, but not to define or delimit any invention.

A first aspect provides a system for generating a training dataset for a reranker model, the system comprising: a memory, a communication interface, and a processor operatively coupled to the memory and the communication interface; the processor configured to: for each document of a set of documents, use a large language model (LLM) to generate one or more synthetic queries related to the document; for each generated synthetic query, use the LLM to rank a plurality of documents of the set of documents associated with the synthetic query based on a relevance of the plurality of documents to the synthetic query; and generate the training dataset to include each synthetic query and the ranking of the plurality of documents associated with that synthetic query.

The processor may be configured to, for each generated synthetic query, identify, using the LLM, a plurality of documents of the set of documents that are relevant to the synthetic query; and the plurality of documents associated with the synthetic query may comprise the plurality of documents of the set of documents that are relevant to the synthetic query.

The processor may be configured to identify, using the LLM, the plurality of documents of the set of documents that are relevant to the synthetic query by, for each document of the set of documents, providing the LLM with a relevance few-shot prompt that instructs the LLM to determine whether the document is relevant to the synthetic query.

The processor may be configured to identify, using the LLM, the plurality of documents of the set of documents that are relevant to the synthetic query by: using a retriever model to retrieve a predetermined number of documents of the set of documents related to the synthetic query; and for each retrieved document, providing the LLM with a relevance few-shot prompt that instructs the LLM to determine whether the retrieved document is relevant to the synthetic query.

The retriever model may be configured to select the predetermined number of documents of the set of documents related to the synthetic query based on best match 25 (BM25).

The relevance few-shot prompt may comprise one or more examples, each example comprising an example query, an example document or an example portion of a document, and an indication of whether the example document or the example portion of the document is relevant to the example query.

The processor may be configured use the LLM to rank the plurality of documents of the set of documents associated with the synthetic query based on the relevance of the plurality of documents to the synthetic query via pairwise ranking prompting.

Pairwise ranking prompting may comprise, for pairs of documents in the plurality of documents of the set of documents associated with the synthetic query, providing the LLM with a pair ranking few-shot prompt that instructs the LLM to determine which document of the pair of documents is more relevant to the synthetic query.

The processor may be configured to use the LLM to generate the one or more synthetic queries related to a document by providing a query few-shot prompt to the LLM that instructs the LLM to generate a synthetic query that is answered by the document, wherein the query few-shot prompt comprises a plurality of example document-query pairs.

The processor may be configured to use the LLM to generate the one or more synthetic queries related to the document by dividing the document into one or more chunks corresponding to portions of text and instructing the LLM to generate a synthetic query for each of the one or more chunks.

The processor may be configured to, for each generated synthetic query, determine whether the synthetic query satisfies a quality requirement; and only use the LLM to rank a plurality of documents of the set of documents associated with the synthetic query based on the relevance of the plurality of documents to the synthetic query if it has been determined that the synthetic query satisfies the quality requirement.

The processor may be configured to determine whether the synthetic query satisfies the quality requirement by using the LLM to determine whether the synthetic query is relevant to the related document.

The processor may be configured to, for each synthetic query, instruct the LLM to generate a response to the synthetic query from the related document, and determine that the synthetic query does not satisfy the quality requirement if the LLM is unable to generate the response to the synthetic query from the related document.

The processor may be configured to receive, from a user, an adjusted ranking of the plurality of documents of the set of documents associated with the synthetic query; and replace the ranking of the plurality of documents of the set of documents associated with the synthetic query in the training data set with the adjusted ranking of the plurality of documents of the set of documents associated with the synthetic query.

The processor may be configured to train the reranker model using the training data set to generate a trained reranker model.

The processor may be configured to: generate, during the training of the reranker model, information identifying a synthetic query with an incorrect ranking of the plurality of documents of the set of documents associated with the identified synthetic query; provide the information to a user; receive, from the user, an adjusted ranking of the plurality of documents of the set of documents associated with the identified synthetic query; replace the ranking of the plurality of documents of the set of documents associated with the identified synthetic query in the training dataset with the adjusted ranking of the plurality of documents of the set of documents associated with the identified synthetic query.

The processor may be configured to perform an information retrieval task on the set of documents using an information retrieval system comprising the trained reranker model.

A second aspect provides a method for generating a training dataset for a reranker model, the method executed in a computing environment comprising one or more processors, a communication interface, and memory, and the method comprising: for each document of a set of documents, using a large language model (LLM) to generate one or more synthetic queries related to the document; for each generated synthetic query, using the LLM to rank a plurality of documents of the set of documents associated with the synthetic query based on a relevance of the plurality of documents to the synthetic query; and generating the training dataset to include each synthetic query and the ranking of the plurality of documents associated with that synthetic query.

The method may further comprise, for each generated synthetic query, identifying, using the LLM, a plurality of documents of the set of documents that are relevant to the synthetic query; and the plurality of documents associated with the synthetic query may comprise the plurality of documents of the set of documents that are relevant to the synthetic query.

A second aspect provides a non-transitory computer readable medium storing computer executable instructions which, when executed by at least one computer processor, cause the at least one computer processor to carry out a method for generating a training dataset for a reranker model, the method comprising: non-transitory computer readable medium storing computer executable instructions which, when executed by at least one computer processor, cause the at least one computer processor to carry out a method for generating a training dataset for a reranker model, the method comprising: for each document of a set of documents, using a large language model (LLM) to generate one or more synthetic queries related to the document; for each generated synthetic query, using the LLM to rank a plurality of documents of the set of documents associated with the synthetic query based on a relevance of the plurality of documents to the synthetic query; and generating the training dataset to include each synthetic query and the ranking of the plurality of documents associated with that synthetic query.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 is a schematic block diagram of an example system for generating a training dataset for a reranker model;

FIG. 2 is a schematic block diagram of an example implementation of the cloud-based computing cluster of FIG. 1 that comprises first, second and third pipelines for generating a training dataset for a reranker model;

FIG. 3 is a block diagram of an example computer;

FIG. 4 is flow diagram of an example method of generating a training dataset for a reranker model;

FIG. 5 is a flow diagram of an example method of using an LLM to generate synthetic queries related to a set of documents; and

FIG. 6 is a flow diagram of an example method of identifying documents relevant to a set of synthetic queries.

### DETAILED DESCRIPTION

As described above, IR systems may implement a two-phase system that comprises a first, retriever stage, in which a retriever model is used to retrieve a set of document from a corpus of documents that are relevant to a user query; and a second, reranker stage, in which reranker models are use to rank the documents retrieved in the first phase based on their relevance to the query.

The effectiveness of a reranker model in ranking documents relative to search queries can be improved for specialised domains if the reranker model is trained on domain specific queries and documents. However, generating a training dataset for a specialised domain may require a significant amount of manual human time and labour to formulate diverse queries, annotate the rankings and providing continuous feedback to the reranker model during training.

Accordingly, described herein are methods and system for using large language models (LLMs) to generate a training dataset (i.e., a labelled dataset) for a corpus of documents which may reduce the amount of human intervention to generate such a training dataset. Specifically, in the systems and methods described herein LLMs are used to automate the generation of at least an initial training dataset. For example, in some examples, an LLM is used to generate synthetic queries related to a corpus of documents; and then an LLM is used to, for each synthetic query, rank a plurality of documents in the corpus associated with the synthetic query based on their relevance to the synthetic query. A training dataset for the reranker model may then be generated that includes each synthetic query and the ranking of the plurality of documents associated therewith. In some cases, the training dataset my be used to train the reranker model. In some cases, prior to training or during training, a user may modify the training data set by adjusting the ranking of the plurality of documents associated with one or more of the synthetic queries. Once trained, the reranker model may be used in IR applications performed on the corpus of documents.

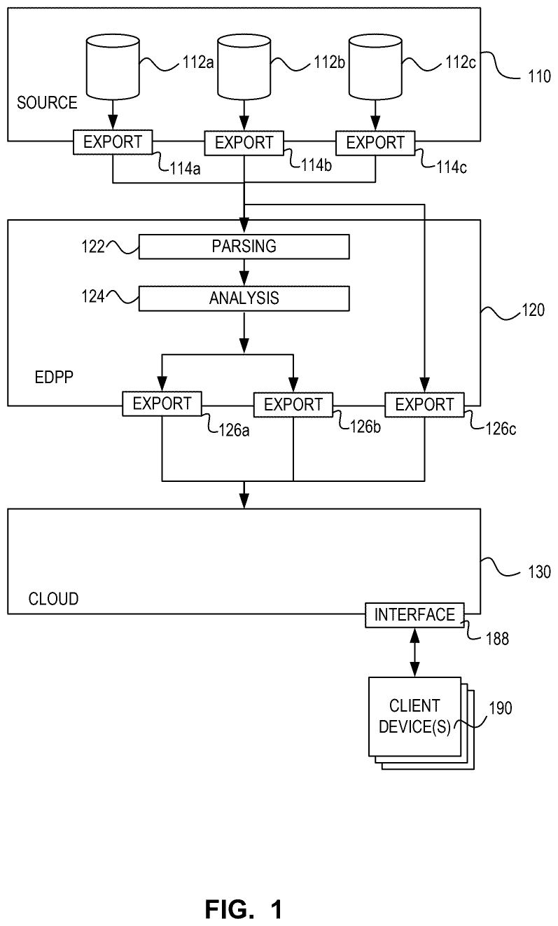

Reference is now made to FIG. 1, which illustrates a block diagram of an example computing system 100, in accordance with at least some embodiments. Computing system 100 comprises a source database system 110, an enterprise data provisioning platform (EDPP) 120 operatively coupled to the source database system 110, and a cloud-based computing cluster 130 that is operatively coupled to the EDPP 120. In some cases, this computing system 100 is provided for generating a training dataset for a reranker model, and optionally training the reranker model using the training dataset and/or performing an IR task using the trained reranker model. In some cases, the documents are files that include text. In some cases, different data formats of documents or files (or both), and which include text, can be used in the computing system described herein.

Source database system 110 has one or more databases, of which three are shown for illustrative purposes: database 112a, database 112b and database 112c. One or more of the databases of the source database system 110 may contain confidential information that is subject to restrictions on export. One or more export modules 114a, 114b, 114c may periodically (e.g., daily, weekly, monthly, etc.) export data from the databases 112a, 112b, 112c to EDPP 120. In some instances, the data is exported on an ad hoc basis.

EDPP 120 receives source data exported by the export modules 114a, 114b, 114c of source database system 110, processes it and exports the processed data to an application database within the cloud-based computing cluster 130. For example, a parsing module 122 of EDPP 120 may perform extract, transform and load (ETL) operations on the received source data.

In many environments, access to the EDPP may be restricted to relatively few users, such as administrative users. However, with appropriate access permissions, data relevant to a document or group of documents (e.g., a client document) may be exported via reporting and analysis module 124 or an export module 126a, 126b, 126c. In particular, parsed data can then be processed and transmitted to the cloud-based computing cluster 130 by a reporting and analysis module 124. Alternatively, one or more export modules 126a, 126b, 126c can export the parsed data to the cloud-based computing cluster 130.

In some cases, there may be confidentiality and privacy restrictions imposed by governmental, regulatory, or other entities on the use or distribution of the source data. These restrictions may prohibit confidential data from being transmitted to computing systems that are not “on-premises” or within the exclusive control of an organization, for example, or that are shared among multiple organizations, as is common in a cloud-based environment. In particular, such privacy restrictions may prohibit the confidential data from being transmitted to distributed or cloud-based computing systems, where it can be processed by machine learning systems, without appropriate anonymization or obfuscation of personal identifiable information (PII) in the confidential data. Moreover, such “on-premises” systems typically are designed with access controls to limit access to the data, and thus may not be resourced or otherwise suitable for use in broader dissemination of the data. In some cases, to comply with such restrictions, one or more module of EDPP 120 may “de-risk” data tables that contain confidential data prior to transmission to cloud-based computing cluster 130. In some cases, this de-risking process may obfuscate or mask elements of confidential data, or may exclude certain elements, depending on the specific restrictions applicable to the confidential data. The specific type of obfuscation, masking or other processing is referred to as a “data treatment.”

The cloud-based computing cluster 130 includes an interface 188, which facilitates data communication with one or more client devices 190.

In some environments, the EDPP may be omitted.

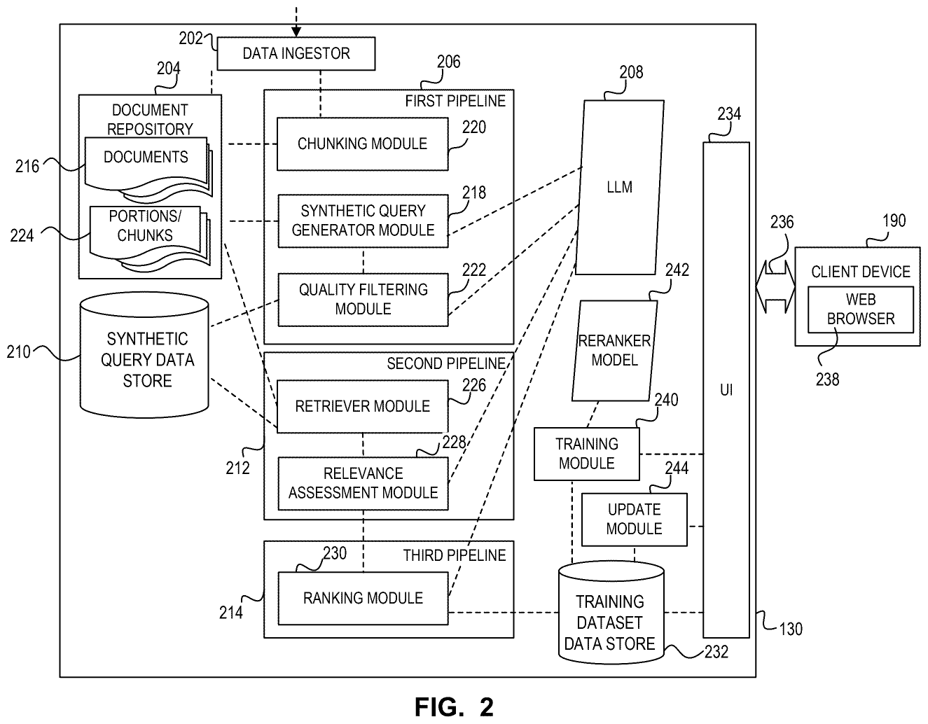

Reference is now made to FIG. 2, which illustrates an example implementation of the cloud-based computing cluster 130 of FIG. 1.

The components of the example cloud-based computing cluster 130 include a data ingestor 202, a document repository 204, a first pipeline 206, a large language model (LLM) 208, a synthetic query data store 210, a second pipeline 212 and a third pipeline 214. In some cases, one or more of these components of the cloud-based computing cluster 130 may be implemented by one or more computers within the cloud-based computing cluster. In some cases, one or more of these components may be implemented as virtual machines within the cloud-based computing cluster.

The document repository 204 is configured to store a set of documents 216 The set of documents 216 may be provided to the document repository 204 via the data ingestor 202. In some cases, the set of documents 216 may comprise a corpus of documents on which IR tasks are to be performed.

The first pipeline 206 is configured to generate synthetic queries related to the set of documents 216. The first pipeline 206 may be implemented by one or more computers. The first pipeline 206 comprises a synthetic query generator module 218, and optionally a chunking module 220 and/or a quality filtering module 222. The synthetic query generator module 218 is configured to use the LLM 208 to generate synthetic queries related to the set of documents. In some cases, the synthetic query generator module 218 may be configured to, for each document in the set of documents 216, use the LLM 208 to generate one or more synthetic queries related to the document. A synthetic query may be related to a document if the query can be answered by the content of the document. The synthetic query generator module 218 may be configured to use the LLM 208 to generate a synthetic query related to a document by providing a query few-shot prompt to the LLM 208 that instructs the LLM 208 to generate a synthetic query that is answered by the document, wherein the query few-shot prompt comprises a plurality of example document-query pairs. An example query few-shot prompt is shown below.
Please ask a good and specific question that can be answered with the given document.
Document 1: {{Example Document}}
Query 1 {{Example Query}}
Document 2: {{Example Document}}
Query 2: {{Example Query}}
Now it is your turn:
Document 3: {{Document}}
Query 3:

The query few-shot prompt induces the LLM 208 to generate a query that algins with (e.g., is in the same format and style as) the example document-query pairs. Generally, the higher the quality and more diverse the example document-query pairs, the more likely the LLM 208 will generate relevant and informative queries. Accordingly, a predefined set of example document-query pairs representative of the desired style and format may be used in the query few-shot prompt. The example query few-shot prompt shown above comprises two example document-query pairs, however, this is an example only and that a query few-shot prompt may comprise any number of example document-query pairs.

In some cases, prior to the synthetic query generator module 218 generating synthetic queries related to the set of documents 216, a chunking module 220 may subdivide or partition each document in the set of documents 216 into one or more portions 224, which may be referred to chunks. The portions 224 of the set of documents 216 may be stored in the document repository 204. In some cases, the chunking module 220 may segment the text in a given document into portions of text. In some cases, semantic chunking is used to segment the text. In other cases, document-based chunking is used to segment the text, which identifies and uses a structure of a document—e.g., headers, paragraphs or spaces. Other examples of chunking computations include recursive chunking and fixed-sized chunking. Other currently known and future known chunking computations can be used by the chunking module 220. The chunking module 220 may receive the set of documents 216 from the data ingestor 202 or the chunking module 220 may retrieve the set of documents 216 from the document repository 204.

Where the documents in the set of documents 216 are sub-divided into portions, the synthetic query generator module 218 may use the LLM 208 to generate a synthetic query related to each portion of each document. For example, the synthetic query generator module 218 may instruct the LLM 208 to generate a query related to each portion of each document in accordance with the example document-query pairs. This allows more than one query to be generated for each document. This may increase the range of content covered by the synthetic queries. This is particularly true when one or more of the documents in the set of documents is long and/or encompasses multiple pieces of information.

In some cases, each of the generated synthetic queries is stored in a synthetic query data store 210 for use by the subsequent pipelines 212, 214. In such cases, the synthetic query generator module 218 may be configured to store the generated synthetic queries in the synthetic query data store 210. In other cases, a synthetic query may only be stored in the synthetic query data store 210 after it has been determined, e.g., by a quality filtering module 222, that the synthetic query satisfies a quality requirement. In other words, synthetic queries that do not satisfy the quality requirement may be discarded if they do not satisfy a quality requirement. In these cases, the quality filtering module 222 may be configured to store synthetic queries that satisfy the quality requirement in the synthetic query data store 210. In either case, each synthetic query stored in the synthetic query data store 210 may be stored together with information identifying the related document or related portion/chunk of a document. In other words, there may be a link between each synthetic query in the synthetic query data store and its related document or related portion/chunk of a document.

In some cases, the quality filtering module 222 may be configured to, for each generated synthetic query, determine whether the synthetic query satisfies the quality requirement by using the LLM 208 to determine whether the synthetic query is relevant to the related document. A synthetic query may be deemed to relevant to the related document if the related document provides an answer or response to the synthetic query. In some cases, the quality filtering module 222 may be configured to determine whether a synthetic query satisfies the quality requirement by providing the LLM 208 with a relevant few-shot prompt that instructs the LLM to determine whether the synthetic query is relevant to the related document, wherein the relevance few-shot prompt comprises one or more examples each of which comprise an example query, an example document or example portion of a document, and an indication of whether the example query is relevant to the example document or the example portion of the document. An example relevance few-shot prompt which may be used to determine if a synthetic query is relevant to the related document is shown below.
Given a document, please generate “yes” if the document is related to the query and “no” if the document is unrelated. Do not generate any other outputs:
Query: {{Example Query}}
Document: {{Example Document}}
Relevant: {{Yes or No}}
Now it is your turn:
Query: {{Synthetic Query}}
Document: {{Document}}
Relevant:

Due to the inherent limitations of LLMs that mean that generated queries may not always align with the related or corresponding document, evaluating the relevance of the synthetic queries to their related documents in this manner can remove synthetic queries that lack contextual context. This can result in a set of synthetic queries with a demonstrably stronger relevance to their related documents.

In other cases, the quality filtering module 222 may be configured to, for each generated synthetic query, use the LLM 208 to generate a response to the synthetic query from the related document, and determine that the synthetic query does not satisfy the quality requirement if the LLM 208 is unable to generate a response to the synthetic query from the related or corresponding document. In some cases, the quality filtering module 222 may be configured to instruct the LLM 208 to generate a response to a synthetic query from its related document by providing the LLM 208 with an extraction prompt that comprises the query, the related document and instructions to generate a concise response to the query from the related document. An example extraction prompt is provided below.
You are an intelligent assistant. You are given a query and a supporting document, please extract an answer from the document. Be brief in your answers and try to extract the most useful part. Please avoid repeating the question. If the document doesn't contain an answer say “no information”.
Do not mention that the answer is based on the document. Please think step by step.
Query: {{Synthetic Query}}
Document: {{Document}}
Your Answer:

The second pipeline 212 is configured to associate each synthetic query generated by the first pipeline 206 with a plurality of documents in the set of documents. The second pipeline 212 may be implemented by one or more computers. The plurality of documents associated with a synthetic query may be selected in any suitable manner. It some cases, it may be beneficial if the plurality of documents associated with a synthetic query are relevant to the synthetic query. A document may be deemed to be relevant to a synthetic query if the document provides an answer or response to the synthetic query. Accordingly, the second pipeline 212 may comprise a retriever module 226 and a relevance assessment module 228 which are configured to identify, using the LLM 208, documents in the set of documents 216 that are relevant to each synthetic query. The retriever module 226 is configured to retrieve a plurality of documents from the set of documents 216 for each synthetic query and the relevance assessment module 228 is configured to determine for each synthetic query which of the plurality of retrieved documents for that synthetic query are relevant to the synthetic query. In these cases, the plurality of documents associated with a synthetic query may be the documents identified by the LLM 208 as being relevant to the synthetic query. Identifying a plurality of documents that are relevant to each synthetic query, instead of only identifying one document relevant to the synthetic query (e.g., the document from which the synthetic query was generated), allows the reranker model to be trained with real-world scenarios where one query can have multiple documents that are relevant to it. A document that is determined to be relevant to a synthetic query may be described as a positive example for that synthetic query, and a document which is determined not to be relevant to synthetic query may be said to form a negative example for that synthetic query such that the relevance assessments performed by the relevance assessment module 228 generate a set of positive examples and a set of negative examples for each synthetic query.

The relevance assessment module 228 may be configured to use the LLM 208 to determine whether a document is relevant to a synthetic query using one of the techniques described above for determining whether a synthetic query meets a quality requirement. For example, in some cases, the relevance assessment module 228 may be configured to determine whether a synthetic query is relevant to a document by asking the LLM 208 whether the document is relevant to the query. As described above, this may comprise providing the LLM 208 with a relevant few-shot prompt that instructs the LLM to determine whether the synthetic query is relevant to the document, wherein the relevance few-shot prompt comprises one or more examples each of which comprise an example query, an example document, and an indication of whether the example query is relevant to the example document. In other cases, the relevance assessment module 228 may be configured to determine whether a document is relevant to a synthetic query by asking the LLM 208 to generate a response to the synthetic query from that document and determining that the document is not relevant to the document if the LLM 208 is unable to generate a response to the synthetic query from the document. As described above, this may comprise providing the LLM 208 with an extraction prompt that comprises the query, the document, and instructions to generate a concise response to the query from the document.

In some cases, retriever module 226 may be configured to retrieve (e.g., from the document repository 204) all the documents in the set of documents 216 for each synthetic query so that the relevance assessment module 228 determines whether each document in the set of documents 216 is relevant to each synthetic query. However, since each synthetic query-document pair assessment is made by asking the LLM 208 to generate text, this may be expensive, in terms of resources and time, to perform for all of the documents. Accordingly, in some cases, to reduce resource consumption and to improve efficiency only a subset of the documents in the set of documents 216 may be selected for relevance assessment for each synthetic query. In these cases, the retriever module 226 may be configured to identify and retrieve only a subset of the documents in the set of documents 216 for relevance assessment for each synthetic query. For example, the retriever module 226 may be configured to identify and retrieve the k most relevant documents in the set of documents 216 according to a ranking algorithm such as, but not limited to, Best Match 25 (BM25), wherein k is an integer greater than 1. BM25 is a ranking algorithm that ranks a set of documents based on the query terms appearing in each document, regardless of their proximity within the document. In some cases, k may be 150.

The third pipeline 214 is configured to, for each synthetic query, use the LLM 208 to rank the plurality of documents associated with the synthetic query (e.g., the documents identified by the second pipeline 212 as being relevant to the synthetic query, which are also referred to as the positive examples for a synthetic query) based on their relevance to the synthetic query. It has been shown that LLMs such as GPT-3.5 can achieve top zero-shot performance by prompting general LLMs to rerank documents. The third pipeline 214 may be implemented by one or more computers.

The third pipeline 214 may comprise a ranking module 230 that is configured to receive, for each synthetic query, the synthetic query and the plurality of documents in the set of documents associated with the synthetic query (e.g., the documents identified by the second pipeline 212 as being relevant to the synthetic query, which are also referred to as the positive examples for a synthetic query) and use the LLM 208 to rank the plurality of documents according to their relevance to the synthetic query. Thus, the output of the ranking module 230 is a ranked list of documents for each synthetic query.

The ranking module 230 may be configured to use the LLM 208 to rank a plurality of documents with respect to their relevance to a query in any suitable manner. In one example, the ranking module 230 may be configured to use the LLM 208 to perform pairwise ranking prompting (PRP). PRP has proven to be an efficient method for an LLM to rank a plurality of documents by relevance to a query. As its name suggests, pairwise ranking prompting involves prompting the LLM to compare and rank pairs of documents. The results of the pairwise rankings are then used to generate a final ranking of the documents.

In one implementation of PRP, each document is individually ranked against each other document. A score is then assigned to each document based on the outcome of the pairwise rankings. The scores assigned to the documents are then used to rank the documents. For example, since LLMs may be sensitive to text orders in prompts, for each pair of documents d₁ and d₂, two rankings may be performed by the LLM 208—i.e., a ranking of d₁ and d₂, and a ranking of d₂ and d₁. If both rankings produce a consistent result (e.g., both rankings indicate that d₁ is more relevant than d₂ to a query) then the identified document may be allocated 1 point and the unidentified document is not allocated any points. In contrast, if the rankings produce inconsistent results (e.g., one ranking indicates that d₁ is more relevant than d₂ to a query, and the other ranking indicates that d₂ is more relevant than d₁ to the query) then each document may be allocated 1 point. The total score for a document may then be the sum of the points allocated to that document. The documents can then be ranked based on their total scores.

While the described implementation of PRP is simple to implement, is prompt order independent, and has proven to be quite effective, it requires O(N²) prompts/calls to the LLM 208 per query, where N is the number of documents to be ranked for a query. Accordingly, in some cases PRP may be implemented in another manner. For example, a pairwise sorting algorithm, such as, but not limited, heap sort and bubble sort, may use the output of a pairwise ranking from the LLM 208 as a comparator for the sorting algorithm. Thus reduces the number of prompt/calls to the LLM 208 to O(N log N). In another example, a sorting window approach which starts at a bottom of a list and compares and swaps documents with a stride of 1 based on the output of a pairwise ranking from the LLM 208.

The ranking module 230 may be configured to use an LLM 208 to rank a pair of documents (A, B) with respect to a query (Q) by providing the LLM 208 with a pair ranking few-shot prompt that comprises one or more example (Q, A, B, answer) quadruples, and instructions for the LLM determine whether A or B is more relevant to Q. An example pair ranking few-shot prompt is shown below.
Given the following question and documents, please generate which document is more relevant for answering the query. The output should be only A or B.
Query: {{Example Query}}
Document A: {{Example Document A}}
Document B: {{Example Document B}}
Answer: {{A or B}}
Now your turn
Query: {{Synthetic Query}}
Document A {{Document A}}
Document B {{Document B}}
Answer: {{A or B}}

In other examples, the ranking module 230 may be configured to use the LLM to perform the ranking in another manner. For example, the ranking module 230 may be configured to use the LLM to perform pointwise or listwise ranking.

Once a ranked list of documents has been generated for each synthetic query, a training dataset for the reranker model may then be generated which includes each synthetic query and associated ranked list of documents (i.e., the ranked list of relevant documents or the ranked list of positive examples). In other words, the training dataset comprises a plurality of query-ranked list of relevant documents pairs. In some cases, the training dataset may also comprise, for each synthetic query, the set of negative examples (i.e., those documents that were identified by the relevance assessment module 228 as not being relevant to the synthetic query), however, in contrast to the positive examples, the negative examples are not ranked. The training dataset may be stored in a training dataset data store 232 and/or provided to a user via a user interface (UI) 234. In some cases, the training dataset is provided to a client device 190 that connects over a data communication link 236 to the user interface 234. For example, a user may access the training dataset via a web browser 238 or some other application that operates on the client device 190.

Once the training dataset has been generated, the training dataset may be used, by a training module 240, to train or fine-tune a reranker model 242. The training performing by the training module 240 may be initiated by a user, via, for example, the user interface 234. The term “reranker model” is used to mean a specialized machine learning model designed to rank documents/passages based on their relevance to a query, such as, but not limited to, a cross-encoder model. Some reranker models may calculate a relevance score for a query-document pair, and the relevance scores can be used to rank a set of documents. A reranker model includes a number of adjustable parameters (e.g., weights) which affect how the reranker model ranks a set of documents. These parameters (e.g., weights) can be adjusted during training to improve performance. Specifically, during training the reranker model 242 is provided with example input-desired output pairs and one or more of the parameters are adjusted so that when the reranker model receives a specified input it will produce the corresponding desired output. In this case, each input comprises a synthetic query and the plurality of related documents, and the desired output is the ranking of those documents with respect to the synthetic query generated by the LLM 208. Thus, training a reranker model using a training dataset generated in accordance with the systems and methods described herein may comprise providing the reranker model with a synthetic query and the plurality of related documents and adjusting the parameters (e.g., weights) so that the reranker model generates a ranking of those documents that is consistent with the ranking generated by the LLM 208. In some cases, a loss metric may be generated for each synthetic query that represents the error in the ranking generating by the reranker model vs the ranking generated by the LLM 208, and the parameters of the reranker model may be adjusted, via, for example, gradient descent, to reduce this loss metric.

For example, let a set of M relevant documents for a synthetic query be denoted d₁, d₂, . . . , d_{M} and the ranking of the i^{th} document dᵢ by the LLM 208 be denoted rᵢ. For example, rᵢ=4 means that dᵢ ranks 4^{th}. If the reranker model is configured to calculate a relevance score sᵢ for a query, q, and a document, dᵢ, then the RankNet loss, R, shown in equation (1) may be used to measure the correctness of the document orderings. The parameters of the reranker model may then be adjusted, via, for example, gradient descent, to minimize the RankNet loss. This is just an example only and other loss metrics or cost metrics may be used.

$$R = {\sum }_{i = 1}^{M} {\sum }_{j = 1}^{M} {f}_{{r}_{i} < {r}_{j}} log ( 1 + exp ( {s}_{i} - {s}_{j} ) ) \qquad ( 1 )$$

$$wherein {f}_{{r}_{i} < {r}_{j}} = \{ \begin{matrix}1 , {r}_{i} < {r}_{j} \\ 0 , otherwise\end{matrix}$$

Once the reranker model 242 has been trained or fine-tuned, the reranker model 242 may be used a part of an IR system to perform an IR task on the set of documents.

An LLM may not always correctly rank the relevant documents for a synthetic query, particularly, if the query and/or the relevant documents relate to subject matter that is not known to the LLM. Accordingly, in some cases, a user may manually modify the relevant document rankings generated by the LLM 208 for one or more of the synthetic queries. For example, in some cases, a user may, prior to training a reranker model based on the training dataset, be provided, via, for example, the user interface 234, with the ranking of relevant documents for one or more of the synthetic queries and the user may review the rankings and, if the user is of the view that the LLM-generated ranking is incorrect, may manually generate an updated ranking. The user may then provide, via, for example, the user interface 234, an updated ranking of related documents for a synthetic query to an update module 244 which is configured to replace the rankings for that synthetic query in the training dataset (e.g., the training data set stored in the training dataset data store 232) with the updated rankings.

In addition, or alternatively, a user may receive feedback from the reranker model 242 during the training process via, for example, the training module 240 and the user interface 234, that identifies poorly performing synthetic queries. A poorly performing synthetic query may be a synthetic query in which the LLM generated ranking of the related documents differs significantly from the reranker model generated ranking of the related documents, especially after several rounds of training. In some cases, where, as described above, the training module is configured to generate a cost or loss metric that measures the correctness of the document orderings generated by the reranker model 242 compared to the document orderings generated by the LLM 208. In these cases, the user may be provided with the cost or loss metric for each synthetic query to identify poorly performing synthetic queries. The user may then manually review the ranking of relevant document generated by the LLM 208 for the poorly performing synthetic queries. If the user is of the view that the LLM-generated ranking for a poorly performing synthetic query is not correct, the user may manually generate an updated ranking for that synthetic query. The user may then provide, via, for example, the user interface 234, the updated ranking for a synthetic query to an update module 244 which is configured to replace the ranking information for that synthetic query in the training dataset (e.g., the training data set stored in the training dataset data store 232) with the updated rankings. The reranker model 242 may then be re-trained using the updated training dataset. By having a user only focus on poorly performing queries the user input is minimized which may enhance system scalability and allow the system to support larger sets of documents.

Although a single LLM is shown in FIG. 2, in other examples there may be multiple LLMs and different LLMs may be used for different functions. For example, one LLM may be used to generate the synthetic queries, whereas another LLM may be used to rank the plurality of documents associated with a synthetic query.

It will be appreciated that, while the components shown in FIG. 2 for the cloud-based computing cluster 130 can be implemented with the system 100 in FIG. 1, in some other cases, the components shown in FIG. 2 are instead implemented in an isolated computing system. In other words, the components shown in FIG. 2 can be implemented as a computing system without the EDPP 120 and the source database system 110.

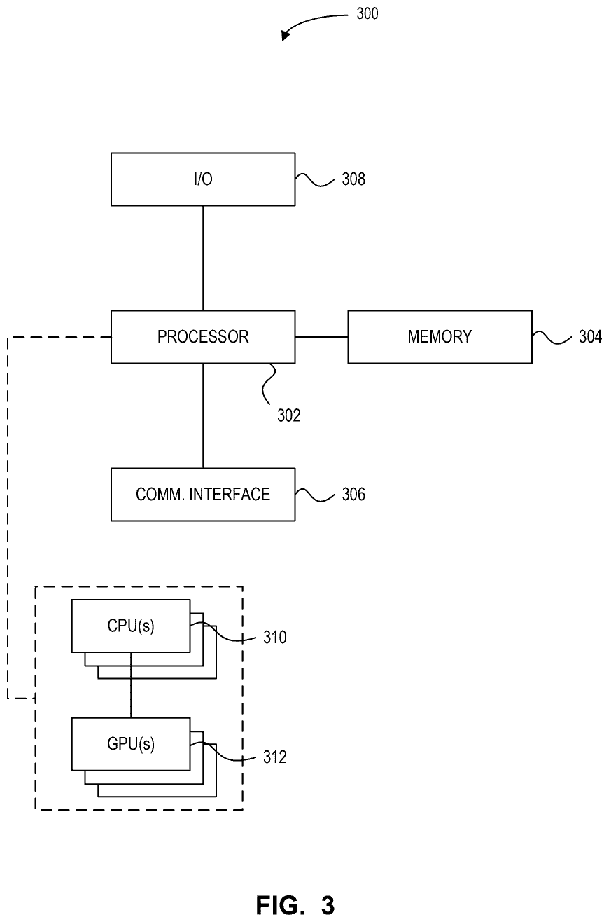

Reference is now made to FIG. 3 which illustrates a simplified block diagram of an example computer 300. Computer 300 is an example implementation of a computer which may implement the source database system 110, EDPP 120, and/or one or more components of the cloud-based computing cluster 130 of FIGS. 1 and 2. Computer 300 has at least one processor 302 operatively coupled to at least one memory 304, at least one communications interface 306 (also referred to herein as a network interface), and at least one input/output (I/O) device 308.

The at least one memory 304 includes a volatile memory that stores instructions executed or executable by the processor 302, and input and output data used or generated during execution of the instructions. The memory 304 may also include non-volatile memory used to store input and/or output data—e.g., within a database—along with program code containing executable instructions.

The processor 302 may transmit or receive data via the communications interface 306 and may also transmit or receive data via any additional input/output device 308 as appropriate.

In some cases, the processor 302 includes a system of central processing units (CPUs) 310. In other cases, the processor 302 includes a system of one or more CPUs 310 and one or more Graphical Processing Units (GPUs) 312 that are coupled together. For example, the LLM 208 and/or the reranker model 242 may execute neural network computations on CPU and GPU hardware, such as the system of CPUs 310 and GPUs 312 of FIG. 3.

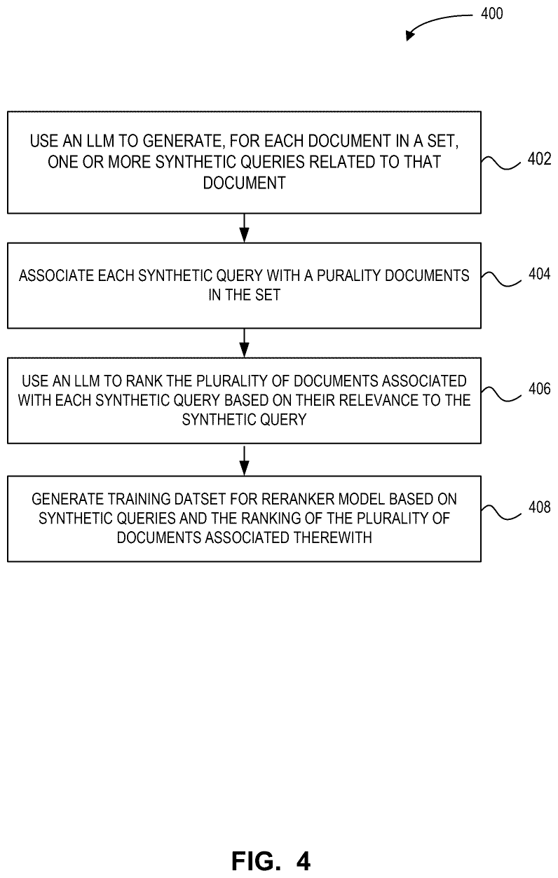

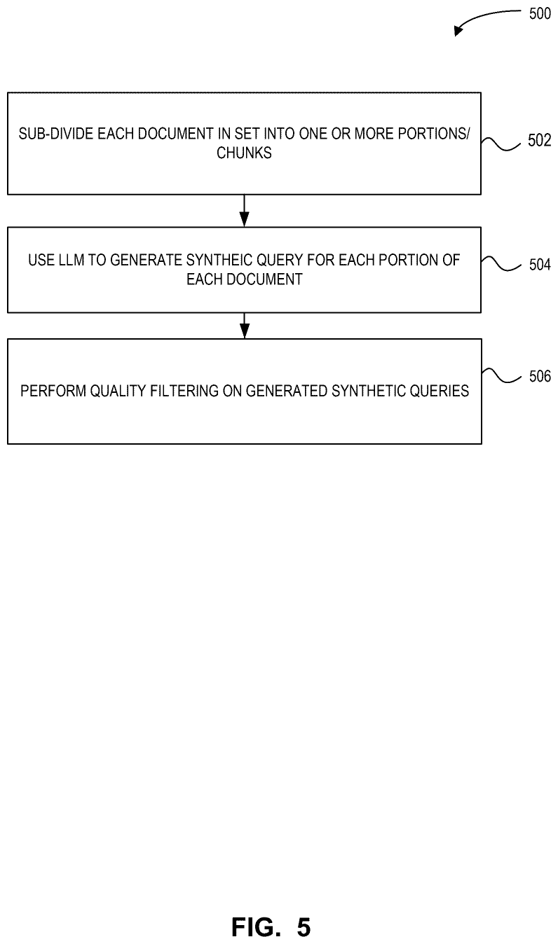

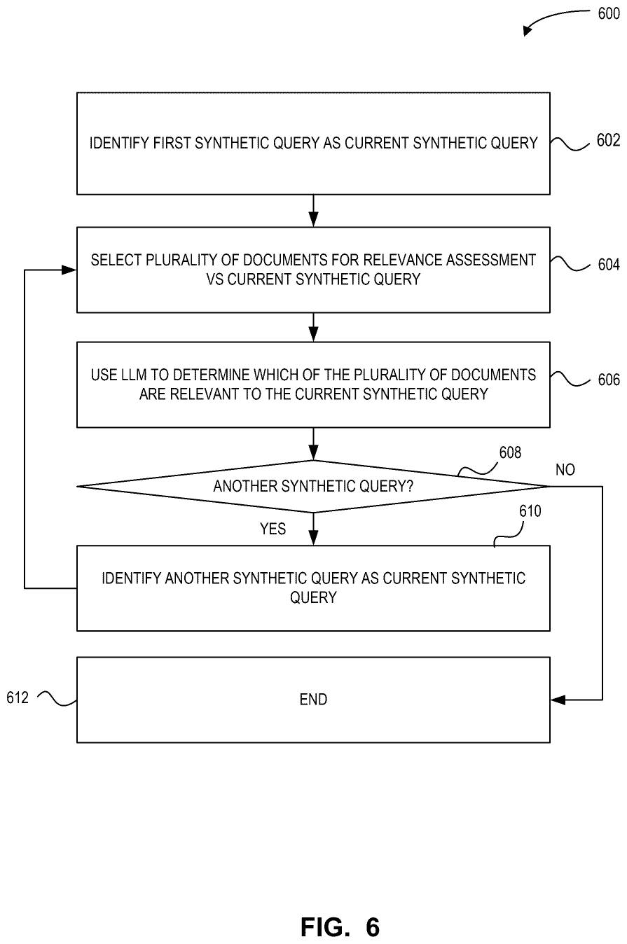

Reference is now made to FIG. 4 which illustrates an example method 400 for generating a training dataset for a reranker model which may be implemented by the cloud-based computing cluster 130 of FIG. 2 or another computing system. The method 400 begins at block 402 where the computing system (e.g., the first pipeline 206 of FIG. 2) uses an LLM to generate, for each document of a set of documents, one or more synthetic queries related to the document. The synthetic queries for the set of documents may be generated by the LLM in any suitable manner. For example, as described above, in some cases, the LLM may be instructed to generate a query for each document or each portion of each document in accordance with one or more example document-query pairs. An example method of generating the synthetic queries is described below with respect to FIG. 5. Once the synthetic queries for the set of documents have been generated, the method 400 proceeds to block 404 where the computing system (e.g., the second pipeline 212 of FIG. 2) associates a plurality of documents of the set of documents with each synthetic query. As described above, in some cases, the plurality of documents associated with a synthetic query may comprise documents of the set of documents that are deemed to be relevant to the synthetic query. An example method for implementing block 404 is described below with respect to FIG. 6. Once each synthetic query has been associated with a plurality of documents of the set of documents, the method 400 proceeds to block 406 where the computing system (e.g., the third pipeline 214 of FIG. 2) uses an LLM 208, for each synthetic query, to rank the plurality of documents associated with the synthetic query based on their relevance to the synthetic query. Any suitable method, such as those described above, of using an LLM 208 to rank a plurality of documents with respect to their relevance to a query may be used. In one example, the LLM 208 may be configured perform pairwise ranking prompting (PRP). Once the plurality of documents associated with each synthetic query have been ranked by the LLM, the method 400 proceeds to block 408 where a training dataset for the reranker model is generated that comprises each of the synthetic queries and the ranking of the plurality of documents associated therewith.

Although in the example method 400 of FIG. 4 each block 402, 404, 406 is fully competed before the next block is started, in other examples, the blocks may be implemented in parallel. For example, as soon as a synthetic query has been generated in block 402, blocks 404, 406, 408 may be executed for that synthetic query—i.e., before all the synthetic queries have been generated. Accordingly, blocks 402, 404, 406, 408 may be executed in parallel for different documents and/or different synthetic queries.

Reference is now made to FIG. 5 which illustrates an example method 500 of using an LLM to generate synthetic queries related to a set of documents. The method 500 of FIG. 5 may be used to implement block 402 of the method 400 of FIG. 4. The method 500 begins at block 502 where each document of the set of documents is sub-divided into one or more portions (which may also be referred to as chunks) of text. A document may be divided into portions of text using any suitable method such as, but not limited to, the chunking methods described above with respect to FIG. 2. Once the documents in the set have been sub-divided into portions or chunks, the method 500 proceeds to block 504.

At block 504, an LLM is used to generate a synthetic query related to each portion of each document. In some cases, using the LLM to generate a synthetic query for a portion of a document may comprise providing a query shot prompt to the LLM that instructs the LLM to generate a synthetic query that is answered by the portion of the document, wherein the query few-shot prompt comprises a plurality of example document-query pairs. As described above, the example document-query pairs are selected so as to provide examples of desired formats and styles for the queries. An example query few-shot prompt was provided above. The generated synthetic queries may be stored in a synthetic query data store. Once the synthetic queries have been generated, the method proceeds to block 506.

At block 506, quality filtering is performed on the synthetic queries generated in block 504. This may comprise determining whether each synthetic query generated in block 504 satisfies a quality requirement. A synthetic query that does not satisfy the quality requirement may be discarded (e.g., the synthetic query may not be stored in the synthetic query data store). In some cases, determining whether a synthetic query satisfies a quality requirement may comprise using an LLM to determine whether the synthetic query is relevant to the related document. This may comprise providing the LLM with a relevance few-shot prompt that instructs the LLM to determine whether the synthetic query is relevant to the document, wherein the relevance few-shot prompt comprises one or more examples, each example comprising an example query, an example document or example portion of a document, and an indication of whether the example query is relevant to the example document or example portion of a document. An example relevance few-shot prompt was provided above. In other cases, determining whether a synthetic query satisfies a quality requirement may comprise instructing an LLM to generate a response to the synthetic query from the related document and determining that the synthetic query does not satisfy the quality requirement if the LLM is unable to generate a response to the synthetic query from the related document. In these cases, where it is determined that a synthetic query satisfies the quality requirement, the generated response (e.g., the synthetic response) may be stored in the synthetic query data store along with the synthetic query. Once the quality filtering has been performed on the generated synthetic queries, the method 500 may end.

The method 500 of FIG. 5 is only an example method of generating synthetic queries related to a set of documents and in other examples not all of the blocks of the method 500 of FIG. 5 may be implemented. For example, in other methods one or more of blocks 502 and 506 may not be implemented. In other words, blocks 502 and 506 are optional. If block 502 is not implemented then instead of using the LLM to generate a query for each portion of each document, the LLM may be used to generate one or more queries for each document as a whole.

Furthermore, although in the example method 500 of FIG. 5 each block 502, 504, 506 is fully completed before the next block is started, in other examples, the blocks may be implemented in parallel. For example, as soon a portion or chunk has been generated in block 502, blocks 504 and 506 may be executed for that chunk—i.e., before all the documents in the set have been subdivided into chunks. In such a manner, blocks 502, 504 and 506 may be executed in parallel for different documents/chunks and/or different synthetic queries.

Reference is now made to FIG. 6 which illustrates an example method 600 for identifying, for each of a plurality of synthetic queries, a plurality of documents in a set of documents that are relevant to the synthetic query. The method 600 of FIG. 6 may be used to implement block 404 of the method 400 of FIG. 4. The method 600 begins at block 602 where a first synthetic query of the plurality of queries is identified as the current synthetic query. Once the current synthetic query has been identified, the method 600 proceeds to block 604 where a plurality of documents of the set of documents are selected for relevance assessment with respect to the current synthetic query. In some cases, all of the documents in the set may be selected for relevance assessment. However, in other cases, to reduce the resources and time to implement the relevance assessment only a subset of the documents in the set of documents may be selected for relevance assessment. As described above, in some cases, the k most relevant documents to the synthetic query according to a ranking algorithm such as, but not limited to, Best Match 25 (BM25) may be selected, wherein k is an integer greater than 1. Once a plurality of documents of the set of documents have been selected for relevance assessment with respect to the current synthetic query, the method 600 proceeds to block 606.

At block 606, an LLM is used to determine which of the documents of the plurality of documents selected in block 604 are relevant to the current synthetic query. Example methods and techniques for using an LLM to determine whether a document is relevant to a synthetic query were described above. For example, determining whether a document is relevant to a query may comprise asking an LLM whether the document is relevant to the query. As described above, this may comprise providing the LLM with a relevant few-shot prompt that instructs the LLM to determine whether the synthetic query is relevant to the related document, wherein the relevance few-shot prompt comprises one or more examples each of which comprise an example query, an example document, and an indication of whether the example query is relevant to the example document. In other cases, determining whether a document is relevant to a synthetic query may comprise asking an LLM to generate a response to the synthetic query from that document and determining that the document is not relevant to the document if the LLM 208 is unable to generate a response to the synthetic query from the document. As described above, this may comprise providing the LLM with an extraction prompt that comprises the query, the document, and instructions to generate a concise response to the query from the related document. The set of documents that are identified as being relevant to the current synthetic query may be described as the relevant documents or the positive examples for the current synthetic query. Once the documents that are relevant to the current synthetic query have been identified, the method 600 proceeds to block 608.

At block 608, it is determined whether there is at least one synthetic query for which relevant documents in the set of documents have not been identified. If it is determined that there is at least one synthetic query for which relevant documents in the set of documents have not been identified, then the method 600 proceeds to block 610 where another synthetic query is identified as the current synthetic query and the method 600 proceeds back to blocks 604 and 606 where documents in the set of documents relevant to the new current synthetic query are identified. If, however, it is determined that relevant documents have been identified for all of the synthetic queries then the method 600 may end (block 612).

Although in the method 600 of FIG. 6, the synthetic queries are processed one at a time (i.e., relevant documents in the set of documents are identified for the synthetic queries, one synthetic query at a time) in other examples multiple synthetic queries may be processed in parallel. For example, in other examples, blocks 604 and 606 may be executed for multiple different synthetic queries in parallel.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 112a, or 112b). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g., a pushbutton keyboard, mouse, a touchscreen, and the like), and at least one output device (e.g., a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. A system for generating a training dataset for a reranker model, the system comprising:
a memory, a communication interface, and a processor operatively coupled to the memory and the communication interface;
the processor configured to:
for each document of a set of documents, use a large language model (LLM) to generate one or more synthetic queries related to the document;
for each generated synthetic query, use the LLM to rank a plurality of documents of the set of documents associated with the synthetic query based on a relevance of the plurality of documents to the synthetic query; and
generate the training dataset to include each synthetic query and the ranking of the plurality of documents associated with that synthetic query.

2. The system of claim 1, wherein the processor is configured to, for each generated synthetic query, identify, using the LLM, a plurality of documents of the set of documents that are relevant to the synthetic query; and the plurality of documents associated with the synthetic query comprises the plurality of documents of the set of documents that are relevant to the synthetic query.

3. The system of claim 2, wherein the processor is configured to identify, using the LLM, the plurality of documents of the set of documents that are relevant to the synthetic query by, for each document of the set of documents, providing the LLM with a relevance few-shot prompt that instructs the LLM to determine whether the document is relevant to the synthetic query.

4. The system of claim 2, wherein the processor is configured to identify, using the LLM, the plurality of documents of the set of documents that are relevant to the synthetic query by:
using a retriever model to retrieve a predetermined number of documents of the set of documents related to the synthetic query; and
for each retrieved document, providing the LLM with a relevance few-shot prompt that instructs the LLM to determine whether the retrieved document is relevant to the synthetic query.

5. The system of claim 4, wherein the retriever model is configured to select the predetermined number of documents of the set of documents related to the synthetic query based on best match 25 (BM25).

6. The system of claim 4, wherein the relevance few-shot prompt comprises one or more examples, each example comprising an example query, an example document or an example portion of a document, and an indication of whether the example document or the example portion of the document is relevant to the example query.

7. The system of claim 1, wherein the processor is configured use the LLM to rank the plurality of documents of the set of documents associated with the synthetic query based on the relevance of the plurality of documents to the synthetic query via pairwise ranking prompting.

8. The system of claim 7, wherein pairwise ranking prompting comprises, for pairs of documents in the plurality of documents of the set of documents associated with the synthetic query, providing the LLM with a pair ranking few-shot prompt that instructs the LLM to determine which document of the pair of documents is more relevant to the synthetic query.

9. The system of claim 1, wherein the processor is configured to use the LLM to generate the one or more synthetic queries related to a document by providing a query few-shot prompt to the LLM that instructs the LLM to generate a synthetic query that is answered by the document, wherein the query few-shot prompt comprises a plurality of example document-query pairs.

10. The system of claim 1, wherein the processor is configured to use the LLM to generate the one or more synthetic queries related to the document by dividing the document into one or more chunks corresponding to portions of text and instructing the LLM to generate a synthetic query for each of the one or more chunks.

11. The system of claim 1, wherein the processor is configured to, for each generated synthetic query, determine whether the synthetic query satisfies a quality requirement; and only use the LLM to rank a plurality of documents of the set of documents associated with the synthetic query based on the relevance of the plurality of documents to the synthetic query if it has been determined that the synthetic query satisfies the quality requirement.

12. The system of claim 11, wherein the processor is configured to determine whether the synthetic query satisfies the quality requirement by using the LLM to determine whether the synthetic query is relevant to the related document.

13. The system of claim 11, wherein the processor is configured to, for each synthetic query, instruct the LLM to generate a response to the synthetic query from the related document, and determine that the synthetic query does not satisfy the quality requirement if the LLM is unable to generate the response to the synthetic query from the related document.

14. The system of claim 1, wherein the processor is configured to receive, from a user, an adjusted ranking of the plurality of documents of the set of documents associated with the synthetic query; and replace the ranking of the plurality of documents of the set of documents associated with the synthetic query in the training data set with the adjusted ranking of the plurality of documents of the set of documents associated with the synthetic query.

15. The system of claim 1, wherein the processor is configured to train the reranker model using the training data set to generate a trained reranker model.

16. The system of claim 15, wherein the processor is configured to:
generate, during the training of the reranker model, information identifying a synthetic query with an incorrect ranking of the plurality of documents of the set of documents associated with the identified synthetic query;
provide the information to a user;
receive, from the user, an adjusted ranking of the plurality of documents of the set of documents associated with the identified synthetic query;
replace the ranking of the plurality of documents of the set of documents associated with the identified synthetic query in the training dataset with the adjusted ranking of the plurality of documents of the set of documents associated with the identified synthetic query.

17. The system of claim 15, wherein the processor is configured to perform an information retrieval task on the set of documents using an information retrieval system comprising the trained reranker model.

18. A method for generating a training dataset for a reranker model, the method executed in a computing environment comprising one or more processors, a communication interface, and memory, and the method comprising:
for each document of a set of documents, using a large language model (LLM) to generate one or more synthetic queries related to the document;
for each generated synthetic query, using the LLM to rank a plurality of documents of the set of documents associated with the synthetic query based on a relevance of the plurality of documents to the synthetic query; and
generating the training dataset to include each synthetic query and the ranking of the plurality of documents associated with that synthetic query.

19. The method of claim 18, further comprising, for each generated synthetic query, identifying, using the LLM, a plurality of documents of the set of documents that are relevant to the synthetic query; and wherein the plurality of documents associated with the synthetic query comprises the plurality of documents of the set of documents that are relevant to the synthetic query.

20. A non-transitory computer readable medium storing computer executable instructions which, when executed by at least one computer processor, cause the at least one computer processor to carry out a method for generating a training dataset for a reranker model, the method comprising:
for each document of a set of documents, using a large language model (LLM) to generate one or more synthetic queries related to the document;
for each generated synthetic query, using the LLM to rank a plurality of documents of the set of documents associated with the synthetic query based on a relevance of the plurality of documents to the synthetic query; and
generating the training dataset to include each synthetic query and the ranking of the plurality of documents associated with that synthetic query.
